(19) United States
(12) Patent Application Publication
(10) Pub. No.: US 2018/0185941 A1
(43) Pub. Date: Jul. 5, 2018

(54) Thread taps for wood workpieces

(71) Applicant: Andrew J. Klein, Parker, CO (US)

(72) Inventor: Andrew J. Klein, Parker, CO (US)

(21) Appl. No.: 15/862,309

(22) Filed: Jan. 4, 2018

Related U.S. Application Data
(60) Provisional application No. 62/442,038, filed on Jan. 4, 2017.
(60) Provisional application No. 62/460,525, filed on Feb. 17, 2017.

(51) Int. Cl. B23G 5/06; F16B 25/00

(52) U.S. Cl. CPC B23G 5/068; F16B 25/0015

(57) ABSTRACT

A tap cutting tool comprising a first end configured to engage with a chuck of a drill and a second end having one or more thread cutting surfaces spaced apart around the perimeter of the second end and each thread cutting surface extending at least partially along a length of the second end with a void space or flute positioned between each adjacent thread cutting surface. The tap cutting tool is configured to produce a threaded hole in a non-metal workpiece when rotated.

### CROSS-REFERENCE TO RELATED APPLICATIONS

This application claims the benefit of U.S. Provisional Patent Application Ser. No. 62/442,038, filed on Jan. 4, 2017 and U.S. Provisional Patent Application Ser. No. 62/460,525, filed on Feb. 17, 2017, the contents of which are hereby incorporated in their entireties.

### BACKGROUND

The present invention relates to tools for cutting threads in wood, and storage assemblies for these tools. More specifically, this disclosure relates to the set of tools capable of quickly cutting standard thread dimensions in wood, when used with a drill.

Numerous products exist to tap threads into a workpiece, but tap cutting tools meant for cutting wood threads in conjunction with a handheld power drill do not exist. Tap cutting tools for metals are generally insufficient for use with wood work pieces.

While there are ways to attach threaded metal fasteners into wood fixtures, the prior art methods generally comprise inserts and t-nuts to add threaded connections to a jig. However, tap cutting tools will split or otherwise damage wooden work pieces as many woods lack the necessary machinability and holding capacity. Thus, tap cutting tools of the prior art are limited to working with very dense, hard and fine grained woods as these woods are more forgiving. Further, the wood must have a greater thickness for the tap cutting tools of the prior art to successfully add a threaded portion to the wood.

### SUMMARY

An aspect of the present disclosure relates to a tap cutting tool comprising a first end configured to engage with a chuck of a drill and a second end having one or more spaced apart thread cutting surfaces and one or more void spaces positioned between the adjacent thread cutting surfaces. The one or more thread cutting surfaces are spaced apart around the perimeter of the second end and each thread cutting surface extends at least partially along a length of the second end of the tool. A shaft connects the first end and the second end such that the tap cutting tool is configured to produce a threaded hole in wood when rotated a selected depth into a thickness of the workpiece. The tap cutting tools is configured for use with non-metal workpieces. For example, the non-metal workpiece may be a wood workpiece or workpiece comprised of a fiberboard or other composite, wood like materials.

The tap cutting tool is a cylindrical tool having an overall length of four or more inches and the first end has a multi-sided outer circumference configured to engage with a standard three-jaw chuck of a drill, wherein the drill is a hand held drill or is a drill press.

Another aspect of the present disclosure relates to a method of producing threaded tap holes in a work piece comprised of wood. The method comprises inserting a first end of a tap cutting tool into a chuck of a drill and inserting a second, opposing end of the tap cutting tool into a pre-drilled hole in the wood work piece. The drill is used to rotate the tool such that rotating the first end of the tap cutting tool in a first direction rotates the second end of the tap cutting tool into the thickness of the wood workpiece for forming the threaded tap hole. The second end of the tap cutting tool comprises a plurality of spaced apart thread cutting surfaces, the surfaces having a void space positioned between adjacent thread cutting surfaces.

The tool can be withdrawn from the wood once the threaded tap of a selected depth is produced. As the drill rotation is reversed and the threaded end of the tool is removed from the thickness of the wood workpiece, workpiece debris (e.g., shavings) that has accumulated within the void spaces is also removed.

Another aspect of the present disclosure relates to a storage unit for storing the tap cutting tools. The storage unit comprises a case having one or more recessed spaces configured for holding a tap cutting tool of embodiments of the present disclosure. The case is configured with a mounting mechanism having one or more apertures therein for mounting the case to a structure. The structure may be one of a vertical or horizontal surface, wall, or component of a drill press.

The mounting mechanism comprises at least one sloped surface integrally formed on the case, and the sloped surface having one or more apertures there through for receiving mounting hardware for securing the case to the structure. The case also comprises one or more recessed openings positioned near the recessed spaces for receiving the tap cutting tool where these recessed openings aid a user in storage and retrieval of the tap cutting tools in the recessed spaces.

The storage unit may further comprises a second case wherein the second case is configured with one or more spaces configured to receive a drill bit and corresponding recessed openings for storage and retrieval. The first and/or second case then are provided with a closure mechanism, such as magnets and/or hinges configured to secure the first case and the second case together in an open or closed configuration.

### BRIEF DESCRIPTION OF THE DRAWINGS

FIG. 1 is a perspective view of a tap cutting tool for use with wood.

FIG. 2 is a perspective view of an alternative tap cutting tool for use with wood.

### DETAILED DESCRIPTION

This disclosure details tap cutting tools capable of cutting threads into wood, as well as a container to store the tap cutting tool and associated drill bits in several different configurations. The tap cutting tools combine several design elements for ideal and versatile thread cutting in wood. The tap cutting tools can be used with woods of various densities and grains. The tap cutting tools can be used to cut threads into softwood as well as hardwood.

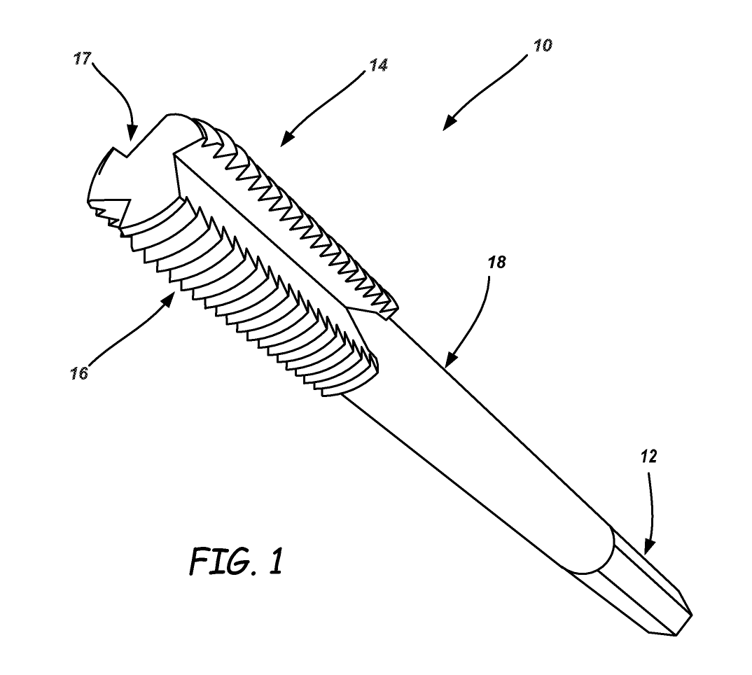

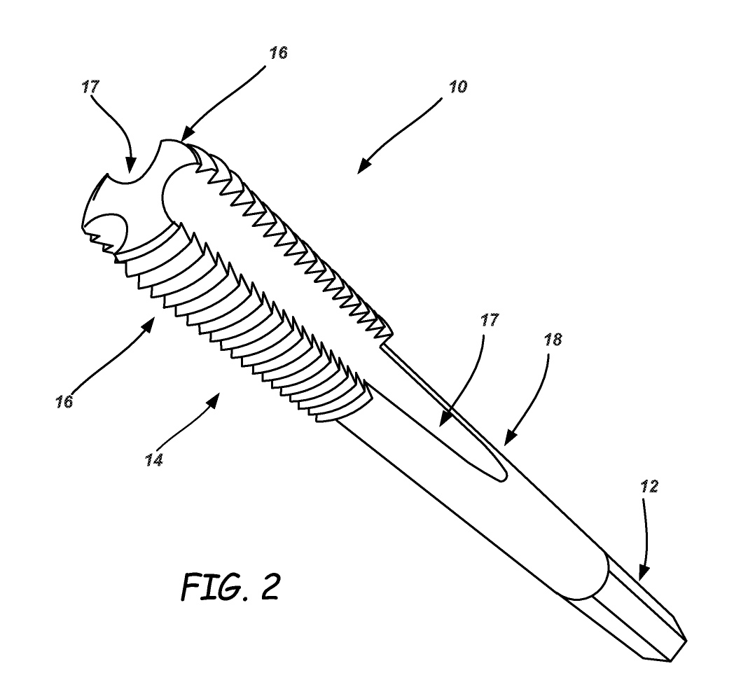

A tap cutting tool 10 for use with wood according to the present disclosure is illustrated generally in FIGS. 1-2. The tap cutting tool 10 is a monolithic shaft machined or constructed from a metal, examples of which include but are not limited to, steel. The tap cutting tool 10 has a first end 12 configured for insertion into a chuck of a drill and a second, opposing end 14 having threaded portions 16 for forming threaded holes in the wood material or workpiece. The first end 12 and the end 14 are connected by a shaft length 18.

The first end 12 of the tap cutting tool 10 comprises an end configured to mount in a standard three-jaw chuck, which is generally used with power hand drills. In the embodiment illustrated, the first end 12 is hexagonal. Those well versed in the art will recognize that alternative methods of easy mounting in a three-jaw chuck exist and that the tap can include a shaft end that employs three flat faces, the extension of which would form an equilateral triangle.

The second end 14 of the tap cutting tool 10 comprises one or more threaded portions 16 circumferentially spaced around the second end 14. The threaded portions 16 are also referred to as “thread cutters” 16 throughout this disclosure and which produce a full diameter thread in the workpiece after approximately 1 to 2 revolutions of the tap cutting tool 10. The thread cutters 16 are spaced apart by void spaces 17. The void spaces 17 are positioned between the adjacent cutters 16 themselves. This ratio between the space occupied by the cutters 16 and void spaces 17 may be as small as about 1:4 (cutter space:void space).

In the embodiments illustrated, the tap 10 has only three cutting surfaces, thread cutters 16, with larger void spaces 17 between the thread cutters 16. The void spaces 17 may amount to indentations or cavities that provide a cross-sectional shape to the second end 14 that overall may be round or circular, but has one or more edges such that the cross-section is not a standard circle at the threaded end 14 of the tap 10. This allows the tap cutting tool 10 to be used for rapid wood thread cutting because waste material can accumulate within the void spaces 17. This allows for fast cutting with reverse tap operation (reverse drill direction) to clear out chips, shavings or other waste material. Such a practice is only possible for wood and not metal, as metal requires greater torque and cutter strength. Thus, these voids 17 are features that are also absent from current taps meant for metal. For example, the void spaces 17 may constitute as much as approximately 60% of the cross sectional area of the tap cutting section 14.

As illustrated in FIG. 2, the void spaces 17 are flutes 17 between the threaded sections 16. The flutes 17 are smooth fluted extending from the end of the tap 10 along the length of the tap 10 and extend beyond the length of the thread cutter 16. The additional length of the flutes 17 which extends further along the shaft 18 beyond the thread cutters 16 may further aid in debris removal from the non-metal workpiece.

The shaft 18 connects the threaded end 14 and thread cutters 16 with the first end 12, which is configured for engagement with the chuck of a drill as described throughout this disclosure. The shaft 18 is generally of a diameter less than the minor (inner) diameter of the threads. For example, for a course ⅜″ thread cutting tap 10, the shaft 18 diameter is approximately 0.274 inches and the inner thread diameter is approximately 0.3005 inches. In such an embodiment, the outer thread diameter may be approximately 0.375 inches. The diameter of the shaft may be approximately 0.01-0.04 inches less than the minor (inner) diameter of the threads, or more preferably approximately 0.02-0.03 inches less than the minor (inner) diameter of the threads and for example, may be about 0.0265 inches less than the minor diameter of the threads. This allows for deep thread tapping, since the shaft 18 does not interfere with the threads that are being cut into the wood. The shaft 18 terminates in the hexagonal end 12 for easy, non-slip mounting in standard three-jaw chucks, common in hand held drills.

The slope on the initial cutting end of the thread cutters 16 is steep, so that full outer thread cutting is reached rapidly (e.g., one to two revolutions of the tap). The slope angle may be approximately 45 degrees. This is possible with wooden workpieces because the resistance when removing the full thread depth in a small number of revolutions is smaller than in metal.

Threads taps for metals have a major and a minor diameter that is slightly larger than the major and the minor diameters of the bolts that will be threaded into the metal threads formed by the taps. This insures that there is no interference between the metal tapped threads and the bolts. The thread taps 10 configured for materials such as wood (including natural, composite, and/or fabricated wood or wood-like materials) or similar, non-metal workpieces, may have a major and/or a minor diameter that is slightly smaller than the major and/or minor threads of the standard bolts that will be threaded into the wooden holes. Examples include, but are not limited to, the threads of taps 10 having the major and/or minor diameters between about 0.001″ and about 0.05″ less than the corresponding major and/or minor threads of the bolt for use with the hole. What is meant by “inner diameter” and “outer diameter” of the threads is the inner and outer diameters of the helical structure used to convert between rotational and linear movement of force. The major diameter of threads is the larger of two extreme diameters, also referred to commonly as the “outside diameter” of the cross-sectional view taken in a plane containing the axis of the threads. The minor diameter is the lower extreme diameter of the thread (e.g., “inner diameter” or diameter between threads).

The taps 10 form wooden threads in the wood workpiece that are smaller than the bolt to be threaded into the wooden thread. Since wood is a compressible material and the bolt can, to at least some extent, cut and compress the wood fibers as it is threaded into said hole, it will be possible to thread the bolt into a wooden hole that is smaller in diameter than the bolt thus forming a more secure and tighter connection. Because more wood material will remain in the threads of the tap 10 and as the wood has been compressed slightly, the resulting wooden threads will be stronger and less prone to breaking, thus more securely holding the bolt therein. In contrast to taps for forming threaded holes in metal, which require a hole that is larger in diameter than the bolt, the wood taps 10 of the present disclosure can provide a more secure connection in non-metal workpieces, such as wood or composite materials.

Alternative tap 10 geometries that produce threads cut into wood with interferences between the wood threads and threaded bolt are also contemplated. Any tap geometry that results in compressed wood fibers as the bolt is threaded into the threaded hole or aperture formed in the wood material which results in stronger wood threads that are less prone to breaking included in this disclosure.

The overall length of the tap cutting tool 10 is generally greater than (e.g., longer that) currently commercially available taps for metal. For example, the tap cutting tool 10 may be four or more inches long overall. This allows for deep thread cutting in wood or a like material, because in many instances, the depth of threaded holes in wood must be substantially longer than threaded holes in metal.

The tap cutting tool 10 can be made of varying threaded end 14 lengths and shaft 18 lengths and diameters, for different types and sizes of woods while the shaft 18 terminates in the first end 12 that is configured for connection to the chuck of a drill.

For example, the tap cutting tool 10 can come in a variety of threaded end 14 diameters including a high speed steel tap for wood having a 9/16 diameter with a thread size of 12; a high speed steel tap for wood having a ⅜ inch diameter with a thread size of 16; a high speed steel tap for wood having a 7/16 inch diameter and thread size of 14; a high speed steel tap for wood having a ½ inch diameter and thread size of 13; a high speed steel tap for wood having a 5/16 inch diameter and a thread size of 18; or a high speed steel tap for wood having a ¼ inch diameter and thread size of 20. The taps 10 are fluted 17 taps 10 and

Storage solutions for the tap cutting tools and associated drill bits allow for continent transport and storage in multiple configurations. The bits and tap cutting tools are held on opposite sides of a two-part case, with each tool recessed just below the mating surface of the case. A resistance fit, magnet, or other means of securing each tool is utilized to keep it in place. The two halves of the case are coupled magnetically, or by a hinge and latch mechanism, or some alternative means of opening, closing and separating the two halves. The upper end of the case has two slopped surfaces that do not interfere with transporting the tools when the case halves are coupled, and do not interfere with the storage of the tools when the halves are laid flat, in, for example, a tool drawer. The slopped sides do allow for easily mounting the tools on a tool wall, or the post of a drill press with appropriate mounting hardware.

A storage unit (not illustrated) may comprise a case that is configured to receive one or more tap cutting tools 10 including spaces configured to secure and protect the thread cutting taps 10. A second case of similar construction may be provided for holding drill bits used to drill pilot holes prior to thread tapping. The first case of the storage unit may be used by itself or in combination with the second case. The first case may be adapted with spaces of one or more sizes to hold one or more tap cutting tools 10 of the same or varying sizes. Similarly, the second case may be configured to hold the drill bits of the same or varying sizes. The first case may then also be provided with a closure for securing the case to the second case, for example, in a closed position (encasing the tools 10 and drill bits therein). The securing mechanism may be magnets or separable hinges that operably secure the two cases of the storage unit together and allow the storage unit to be closed and opened.

The spaces for holding the tap cutting tools may include an opening that is recessed below an upper surface of the case for easy removal and placement of the taps 10 in the case. Another recess is comprised of two sloped surfaces that allow the case to be easily mounted, for example, on a wall, a tool wall or work bench, or drill press shaft. The case for example, can also be provided with through holes for mounting hardware which allows each half of the case to be mounted, for example, on a wall or drill press shaft.

Although the present disclosure has been described with reference to preferred embodiments, workers skilled in the art will recognize that changes may be made in form and detail without departing from the spirit and scope of the disclosure.

1. A tap cutting tool comprising:
a first end configured to engage with a chuck of a drill;
a second end having one or more thread cutting surfaces spaced apart around the perimeter of the second end and each thread cutting surface extending at least partially along a length of the second end; and
a shaft connecting the first end and the second end,
wherein the tap cutting tool is configured to produce a threaded hole in a non-metal workpiece.

2. The tap cutting tool of claim 1, wherein the tap cutting tool is a cylindrical tool having an overall length of four or more inches.

3. The tap cutting tool of claim 1, wherein the first end has a multi-sided outer circumference configured to engage with a standard three-jaw chuck of a drill, wherein the drill is a hand held drill or is a drill press.

4. The tap cutting tool of claim 1, wherein the second end further comprises one or more void spaces, each void space positioned between adjacent thread cutting surfaces.

5. The tap cutting tool of claim 1, wherein the second end further comprises one or more flutes, each flute is positioned between adjacent thread cutting surfaces and wherein each flute extending at least partially along the length of the second end.

6. The tap cutting tool of claim 5, wherein the one or more thread cutting surfaces extends a first length along the length of the second end and each flute extends a second length along the length of the second end and wherein the second length is greater than the first length.

7. The tap cutting tool of claim 4, wherein the second end comprises three thread cutting surfaces and three void spaces where the void spaces are positioned between adjacent cutting surfaces such that a threaded hole can be formed in the non-metal workpiece with one, two or more revolutions of the tap cutting tool.

8. The tap cutting tool of claim 5, wherein the second end comprises three thread cutting surfaces and three void spaces where the void spaces are positioned between adjacent cutting surfaces such that a threaded hole can be formed in the non-metal workpiece with one, two or more revolutions of the tap cutting tool.

9. The tap cutting tool of claim 1, wherein the shaft has a shaft diameter that is less than a minor (inner) diameter of the second end measured at the thread cutting surfaces.

10. The tap cutting tool of claim 9, wherein the shaft diameter is approximately 0.0265 inches less than the minor diameter of the second end at the thread cutting surfaces.

11. The tap cutting tool of claim 1, wherein a major and a minor diameter of the thread cutting surfaces is less than a major and a minor diameter of a bolt to be secured in the threaded hole in the non-metal workpiece, such that a threaded hole produced in the non-metal workpiece has threads that interfere with threads of the bolt for forming a secure connection of the bolt to the workpiece.

12. The tap cutting tool of claim 1, wherein the non-metal workpiece is a wood workpiece.

13. A method of producing threaded tap holes in a work piece comprised of wood, the method comprising:
inserting a first end of a tap cutting tool into a chuck of a drill;
inserting a second, opposing end of the tap cutting tool into a pre-drilled hole in the wood work piece; and
rotating the first end of the tap cutting tool in a first direction with the drill to rotate the second end of the tap cutting tool into the thickness of the wood workpiece; and
forming a threaded tap in the wood workpiece while rotating the first end of the tap cutting tool and thus rotating the second end of the tap cutting tool which comprises a plurality of spaced apart thread cutting surfaces having a plurality of void spaces positioned between adjacent thread cutting surfaces.

14. The method of claim 13, and further comprising rotating the first end of the tap cutting tool in a second, opposing direction, with the drill to withdraw the second end of the tap cutting tool from the thickness of the wood workpiece and removing any workpiece debris accumulated within the void spaces from the threaded tap formed in the workpiece.

15. The method of claim 13, and selecting the tap cutting tool having a major and a minor diameter of the thread cutting surfaces less than a major and a minor diameter of a bolt to be secured into the threaded hole in the wood workpiece, such that the threaded hole produced in the wood workpiece has threads that interfere with threads of the bolt for forming a secure connection of the bolt to the workpiece.

16. The method of claim 13, wherein the tap cutting tool is a cylindrical tool having an overall length of four or more inches.

17. The method of claim 13, wherein the plurality of void spaces comprise flutes such that the tap cutting tool is a fluted tap cutting tool.
